(19) United States
(12) Patent Application Publication
(10) Pub. No.: US 2008/0103858 A1
(43) Pub. Date: May 1, 2008

(54) System for evaluating distressed buildings

(75) Inventors: James Buckley, Bronx, NY (US); Gregory L. Jost, Bronx, NY (US)

Correspondence Address: BAKER BOTTS L.L.P., 30 ROCKEFELLER PLAZA, 44TH FLOOR, NEW YORK, NY, 10112-4498, US

(73) Assignee: University Neighborhood Housing Program

(21) Appl. No.: 11/980,022

(22) Filed: Oct. 30, 2007

Related U.S. Application Data
(60) Provisional application No. 60/863,460, filed on Oct. 30, 2006.

(51) Int. Cl. G06Q 10/00; G06F 17/30; G06F 17/40

(52) U.S. Cl. 705/7

(57) ABSTRACT

Systems and methods of evaluating buildings that may be physically and/or financially distressed are provided. The disclosed subject matter obtains building condition indicator measurements, applies building condition indicator measurements to a mathematical relationship, and obtains a building score from the mathematical relationship and the building condition indicator measurements.

### CROSS REFERENCE TO RELATED APPLICATION

This application claims priority from U.S. Provisional Application Ser. No. 60/863,460, filed Oct. 30, 2006, which is incorporated by reference herein.

### BACKGROUND

The disclosed subject matter relates to techniques for evaluating buildings that may be physically and/or financially distressed.

There have been concerns about the impact of sharp increases in prices of apartment buildings in the Bronx and other neighborhoods. Conventional banks and financial institutions have provided much of the financing. Despite loan to value ratios of between 70-75%, an increase in operating costs will make it difficult for some properties to stay current on tax and mortgage payments while maintaining the building in good repair and maintaining appropriate services. The impact may be more clearly felt in buildings recently financed with 5 year balloon or adjustable rate mortgages if interest rates rise significantly in the next few years.

Many Bronx buildings suffered when a secondary mortgage investor foreclosed on a large number of properties in the late '80s and early '90s. The secondary mortgage investor suffered major financial losses in the early '90s due to over financing. The foreclosure process was financially costly to the secondary mortgage investor, and it was very costly in less quantifiable ways, to the tenants of the buildings and to the neighborhoods in which the buildings were located.

Unfortunately, current techniques are limited in ability to evaluate buildings that may be physically and/or financially distressed. Such limitations arise from inadequate utilization of violation and lien information. Accordingly, there exists a need for an improved technique to evaluate buildings that may be physically and/or financially distressed.

### SUMMARY OF THE INVENTION

The disclosed subject matter provides systems and methods, incorporating a database, for scoring buildings that may be physically and/or financially distressed by using public records and weighting more recent and more serious factors more heavily. Information in the database can include ownership, building size, housing code violation, city lien, and mortgage holder data for multifamily apartment buildings (6 or more rental units). This information can be compiled from any source including free online sources. The scoring system helps to identify properties that are physically and/or financially distressed.

The system can be used to refer problem buildings, particularly multifamily housing buildings, to organizations and community groups in the affected neighborhood. In addition, the information can be used as part of a program to improve conditions and prevent foreclosures in the relevant multifamily housing market by working with lenders. In order to accomplish this, relationships can be established with lenders to create underwriting criteria and develop a protocol for dealing with problem properties. The system and database of the names can be used as a tool in such relationships to identify potentially distressed properties to lenders. One outcome is repairs being made to housing stock in the relevant neighborhood through increased pressure from the lenders on owners to improve their properties.

The database can be compiled from online community data. In one embodiment, available data from property information sources are used, including building violation data. However, some factors, such as certain violations, may affect scores insignificantly, and therefore may be omitted.

The system disclosed herein was implemented in the New York City borough of the Bronx, has equal applicability to other geographical regions, including at least parts of the boroughs of Manhattan, Brooklyn and Queens, and other cities.

The disclosed subject matter also provides a system for evaluating buildings that may be physically and/or financially distressed. In some embodiments, the system includes an input device for receiving building condition indicator measurements, a processor to apply building condition indicator measurements to a mathematical relationship to obtain a building score, and a data store to store the building score.

The accompanying drawings, which are incorporated and constitute part of this disclosure, illustrate preferred embodiments of the disclosed subject matter and serve to explain its principles.

### BRIEF DESCRIPTION OF THE DRAWINGS

FIG. 1 is a diagram illustrating a method implemented in accordance with some embodiments of the disclosed subject matter;

FIG. 2 is a block diagram of a system in accordance with some embodiments of the disclosed subject matter; and

FIG. 3 is a diagram illustrating another method implemented in accordance with some embodiments of the disclosed subject matter.

While the disclosed subject matter will now be described in detail with reference to the Figs., it is done so in connection with the illustrative embodiments.

### DETAILED DESCRIPTION

Systems and methods of evaluating buildings that may be physically and/or financially distressed are provided. The disclosed subject matter obtains building condition indicator measurements, applies building condition indicator measurements to a mathematical relationship, and obtains a building score from the mathematical relationship and the building condition indicator measurements.

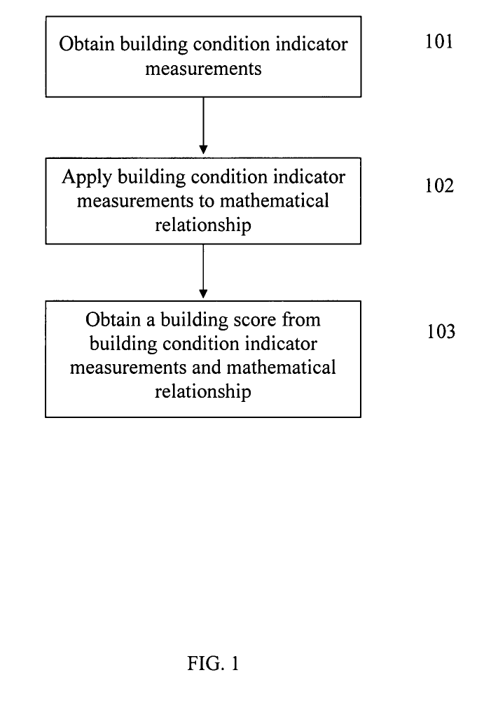

FIG. 1 is a diagram illustrating a method implemented in accordance with some embodiments of the disclosed subject matter. One or more building condition indicator measurements are obtained 101. The measurements can be obtained from government agencies or their websites. Such agencies include the New York City Department of Housing Preservation and Development (“HPD”), the New York City Department of Buildings (“DOB”), and the New York City Department of Finance. Measurements from these agencies can be collected and compiled into a database. The measurements can be manually entered into the database. Additionally, a computer program can be used to search the agency's website, obtain one or more building condition indicator measurements, and transfer one or more building condition indicator measurements into a database. Building condition indicator measurements can include, but are not limited to, HPD violations, HPD C violations, city lien, this year's violations, this year's C violations, violations per unit, C violations per unit, this year's violations per unit, this year's C violations per unit, city lien per unit, lien sale, HPD Emergency Repair Program (“ERP”) lien, ERP lien per unit, water lien, water lien per unit, ECB violations, DOB violations, Environmental Control Board (“ECB”) violations per unit, and DOB violations per unit.

One or more building condition indicator measurements are applied to a mathematical relationship 102. In some embodiments, the mathematical relationship can weight some building condition indicator measurements more heavily than others. For example, HPD C violations can be weighted more heavily than HPC violations, or this year's violations can be weighted more heavily than HPD violations, or this year's violations and violations per unit can be weighted equally, or ERP lien can be weighted more heavily than city lien, or water lien and city lien can be weighted equally.

A building score can be obtained from the mathematical relationship and the building condition indicator measurements 103. Properties that score above a given threshold can be deemed to be in serious financial trouble, or in a poor physical condition, or both.

A formula was created to take account of various factors associated with each building. One such factor includes the various types of violations assessed against each building.

HPD “C” class violations are approximately three times as significant as “A” class violations. “B” class violations are approximately two times as significant as “A” class violations. For efficiency purposes, “C” class violations are separated out from the total violations (“A” class, “B” class, and “C” class) and additionally factored into the formula. For example, the addition of the total violations (“A” class, “B” class, and “C” class) and two times the “C” class violations allows the “C” class violations to be weighted three times as much as the other violations.

It has been observed that recent violations are more significant, and therefore should be weighted more heavily, than older violations. Older violations may not be relevant, because renovations and repairs may have been carried out to mitigate their effect. Also, it can be a difficult process to remove older violations, even if they are no longer applicable, meaning that some listed violations may no longer actually exist. To compensate for this, violations in approximately the last twelve months should be given more weight than older violations. In one embodiment, they are weighted approximately four times as heavily as the older violations. However, both recent violations and older violations preferably are included in the total violations. The recent violations are separated and included as an additional factor. The recent violations preferably are multiplied by a factor of three. For example, the addition of the total violations (recent violations and older violations) and three times the recent violations allows the recent violations to be weighted four times as much as the older violations.

Recent “C” class violations are one of the most important factors in evaluating a building, because they are indicator measurements that there are current serious physical problems in a building. These recent violations can include violations in the past twelve months. They can be weighted more heavily than the other violations. In one embodiment, recent “C” class violations are an additional category that is multiplied by a factor of approximately six. This category can be at least twice as significant as the other categories.

Liens are another important factor. The average number of violations and the average city lien could be given equal weight. One way to mathematically achieve this goal is to divide the total city lien amount by approximately two hundred. In one embodiment, however, the total city lien may be assigned a greater impact on the evaluation of the property, in part because of the increasing risk of tax lien sales occurring in New York City. In order to compensate for this increased risk, the value of the weight associated with city lien may be approximately doubled, thereby reducing the dividing factor by half, to one hundred.

ERP liens preferably are weighted more heavily, because they represent both a serious physical problem with a building and a financial problem. ERP liens are a financial problem, because they have not been fully paid. They can be weighted approximately three times as much as a tax lien or other charges that are past due. ERP liens can be separated from the total liens and other charges and additionally incorporated into the formula. For example, the addition of the total liens (city tax liens, ERP liens, and other charges that are past due) divided by approximately one hundred and the ERP liens divided by fifty allows the ERP liens to be weighted three times as much as the older liens.

Building size can also be taken into account. Smaller buildings with fewer residential units may be less likely to accrue violations than larger buildings with many units. Simply counting violations may unfairly prejudice larger buildings in favor of smaller buildings. Additional factors preferably are applied to mitigate this phenomenon. These factors may include, but are not limited to, dividing the total number of violations by units, dividing the total number of “C” class violations by units, dividing the total number of recent violations by units, and dividing the total number of recent “C” class violations by units. Many of the factors mentioned in the preceding paragraphs can be normalized, or converted into ratios, by dividing the given factor by the number of units. These ratios can then be incorporated into the formula.

In the event of a lien sale on a particular building, additional points may be added to the score of that building. In one embodiment, one hundred points are added to a building's score if a city lien had been sold would in order to more accurately reflect the condition of the building. However, that number may not be sufficient to account for the serious financial problem a lien sale represents. Such a sale may be considered a major risk by a mortgage lender. A significant number of financially distressed properties may receive a low score as a result of the low value of the lien sale factor. Therefore, in another embodiment, approximately five hundred points, instead of one hundred points, are added for a lien sale to provide a more accurate assessment of the condition of the building. Increasing the value of the lien sale would push the scores of these properties much higher and may place many of these properties above a threshold that indicates significant risk.

Properties that score above a given threshold may be deemed to be in serious financial trouble, or in a poor physical condition, or both. In one embodiment, these buildings may pose a risk to investors and/or lenders. In another embodiment, the threshold is preferably set at approximately eight hundred points.

Once the formula is applied, the result as discussed above can be used to identify properties that may need repair, thereby assisting landlords to repair these properties and improve conditions for tenants. The result can also be used to affect loans provided to the properties and to fix interest rates.

In one embodiment, the formula according to the disclosed subject matter is as follows:

Score=(HPD Violations)+(2×HPD C violations)+(ECB Violations)+(DOB Violations)+(city lien/200) (1)

In a different embodiment, the formula is as follows:

Score=(HPD Violations)+(2×HPD C violations)+(3× this year's violations)+(6× this year's C violations)+(ECB Violations)+(DOB violations)+(city lien/200) (2)

In a third embodiment, which accounts for varying building size, as well as lien sales, the formula is as follows:

Score=(HPD violations)+(violations per unit)+(2×HPD C violations)+(2×C violations per unit)+(3× this year's violations)+(3×this year's violations per unit)+(6× this year's C violations)+(6×this year's C violations per unit)+(DOB Violations)+(DOB Violations per unit)+(ECB violations)+(ECB Violations per unit)+(city lien/200)+(city lien per unit/200)+(100 if Lien Sale) (3)

Because the DOB and ECB violations contribute so little to scores, they may be removed in a fourth embodiment as follows:

Score=(HPD Violations)+(violations per unit)+(2×HPD C violations)+(2×C violations per unit)+(3× this year's violations)+(3×this year's violations per unit)+(6× this year's C violations)+(6× this year's C violations per unit)+(city lien/200)+(city lien per unit/200)+(100 if Lien Sale) (4)

In a fifth and particularly preferred embodiment, the formula is as follows:

Score=(HPD Violations)+(violations per unit)+(2×HPD C violations)+(2×C violations per unit)+(3× this year's violations)+(3×this year's violations per unit)+(6× this year's C violations)+(6× this year's C violations per unit)+(city lien/100)+(city lien per unit/100)+(ERP lien/50)+(ERP lien per unit/50)+(500 if Lien Sale) (5)

The formula may be expressed in a database spreadsheet e.g. Microsoft® Excel® as follows:

=(Px+Qx+((Rx+Sx)*2)+((Tx+Ux)*3)+((Vx+Wx)*6)+((Yx+Zx)/100+((AAx+ABx)/50)+(500*ACx)) (6)

where:
P=HPD violations, Q=HPD violations per unit, R=C violations, S=C violations per unit, T=this year's violations, U=this year's violations per unit, V=this year's C violations, W=this year's C violations per unit, Y=city lien, Z=city lien per unit, AA=ERP lien, AB=ERP lien per unit, and AC=lien sale (1 if yes)

If water billing data are available, in a sixth embodiment, the formula could be updated to include this data. The water billing data preferably would be weighted the same way as other city liens, resulting in the following formula:

Score=(HPD Violations)+(violations per unit)+(2×HPD C violations)+(2×C violations per unit)+(3× this year's violations)+(3×this year's violations per unit)+(6× this year's C violations)+(6× this year's C violations per unit)+(water lien/100)+(water lien per unit/100)+(city lien/100)+(city lien per unit/100)+(ERP lien/50)+(ERP lien per unit/50)+(500 if Lien Sale) (7)

In a seventh embodiment, the formula could be updated to weight the per unit factors more heavily in an effort to capture more of the smaller properties. The lien calculation could also be adjusted to capture all properties with an adjusted lien per unit of $3,000:

Score=(HPD Violations)×(violations per unit)+(2×HPD C violations)×(2×C violations per unit)+(3× this year's violations)×(3×this year's violations per unit)+(6× this year's C violations)×(6× this year's C violations per unit)+(2×DOB Violations)×(2×DOB Violations per unit)+(2×ECB violations)×(2×ECB Violations per unit)+(0.26666667×(water lien per unit+city lien per unit+(3×ERP lien per unit))+(500 if Lien Sale) (8)

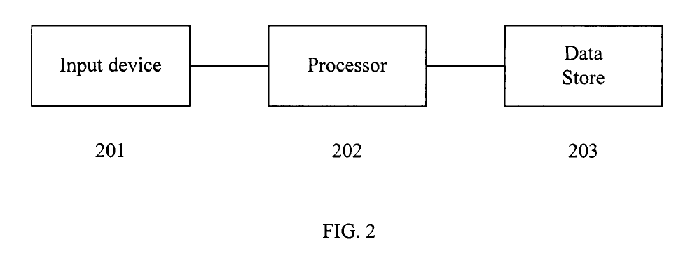

FIG. 2 is a block diagram of system in accordance with some embodiments of the disclosed subject matter. An input device 201, such as a database of building condition indicator measurements, can be used to receive one or more building condition indicator measurements. A processor 202, coupled to the input device, runs appropriate software to apply the building condition indicator measurements to a mathematical relationship to obtain a building score. The processor can be implemented as a computer microchip, a stand alone computer or collection of networks computing or any device suitable for processing.

A data store 203, receives building score (Flow processor 202) and stores the obtained building score. The data store can be implemented as RAM or any other memory device.

A monitor (not shown) or any display device can be used to display the building score.

The disclosed subject matter can be implemented in Perl, C, or other suitable programming language, or any database spreadsheet software.

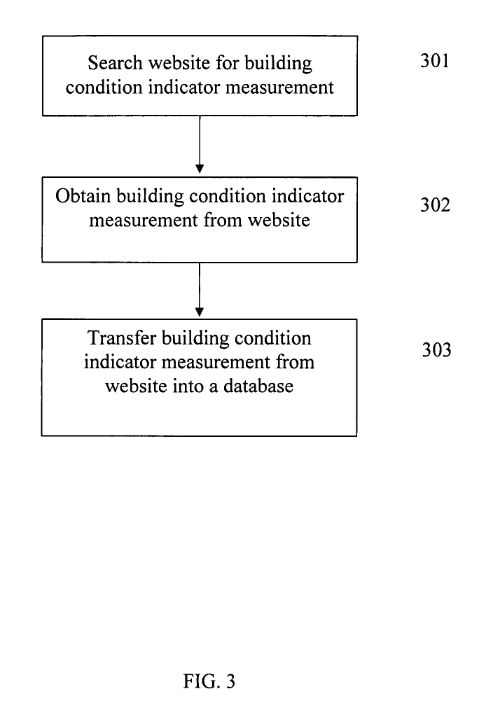

FIG. 3 is a diagram illustrating another method implemented in accordance with some embodiments of the disclosed subject matter. The diagram illustrates a method of creating a database of building condition indicator measurements. Websites are searched for building condition indicator measurements 301. Examples of websites that can be searched for building condition indicator measurements include city agency websites, such as the websites of the New York City Department of Housing Preservation and Development, the New York City Department of Buildings, and the New York City Department of Finance.

Building condition indicator measurements can be copied from these websites 302. For example, lien sale information of a particular building can be obtained from the New York City Department of Finance website.

The building condition indicator measurements can be transferred from the website into a database 303. For example, once the lien sale information is obtained from the New York City Department of Finance website, it can be transferred into a database of building condition indicator measurements and the corresponding buildings.

What is claimed is:

1. A method of evaluating buildings that may be physically and/or financially distressed, comprising:
(a) obtaining one or more building condition indicator measurements;
(b) applying said one or more building condition indicator measurements to a predetermined relationship; and
(c) obtaining a building score from said predetermined relationship and said one or more building condition indicator measurements.

2. The method of claim 1, wherein said building condition indicator measurements comprise HPD violations, HPD C violations, and city lien.

3. The method of claim 2, wherein said predetermined relationship comprises weighting said HPD C violations more heavily than said HPC violations.

4. The method of claim 3, wherein said building condition indicator measurements further comprise the most recent year's violations and the most recent year's C violations.

5. The method of claim 4, wherein said predetermined relationship further comprises weighting said the most recent year's violations more heavily than said HPD violations.

6. The method of claim 5, wherein said building condition indicator measurements further comprise violations per unit, C violations per unit, the most recent year's violations per unit, the most recent year's C violations per unit, city lien per unit, and lien sale.

7. The method of claim 6, wherein said predetermined relationship further comprises weighting said the most recent year's violations and said violations per unit equally.

8. The method of claim 7, wherein said building condition indicator measurements further comprise ERP lien and ERP lien per unit.

9. The method of claim 8, wherein said predetermined relationship further comprises weighting said ERP lien more heavily than said city lien.

10. The method of claim 9, wherein said building condition indicator measurements further comprise water lien and water lien per unit.

11. The method of claim 10, wherein said predetermined relationship further comprises weighting said water lien and said city lien equally.

12. The method of claim 2, wherein said building condition indicator measurements further comprise ECB violations and DOB violations.

13. The method of claim 12, wherein said building condition indicator measurements further comprise ECB violations per unit and DOB violations per unit.

14. Apparatus for evaluating buildings that may be physically and/or financially distressed, comprising:
(a) an input device for receiving one or more building condition indicator measurements;
(b) a processor, coupled to said input device and receiving said one or more building condition indicator measurements therefrom, to apply said one or more building condition indicator measurements to a predetermined relationship to obtain a building score; and
(c) a data store, coupled to said processor and receiving said building score therefrom, for storing said building score.

15. The apparatus of claim 14, wherein said building condition indicator measurements comprise HPD violations, HPD C violations, and city lien.

16. The apparatus of claim 15, wherein said building condition indicator measurements further comprise the most recent year's violations and the most recent year's C violations.

17. The apparatus of claim 16, wherein said building condition indicator measurements further comprise violations per unit, C violations per unit, the most recent year's violations per unit, the most recent year's C violations per unit, city lien per unit, and lien sale.

18. The apparatus of claim 17, wherein said building condition indicator measurements further comprise ERP lien and ERP lien per unit.

19. The apparatus of claim 18, wherein said building condition indicator measurements further comprise water lien and water lien per unit.

20. A method of creating a database of building condition indicator measurements, comprising:
(a) searching one or more websites for one or more building condition indicator measurements;
(b) obtaining said one or more building condition indicator measurements from said one or more websites; and
(c) transferring said one or more building condition indicator measurements from said one or more websites into a database.
